(19) United States
(12) Patent Application Publication
(10) Pub. No.: US 2025/0022142 A1
(43) Pub. Date: Jan. 16, 2025

(54) UV SYSTEM AND METHODS FOR GENERATING AN ALPHA CHANNEL

(71) Applicant: The Invisible Pixel Inc., San Diego, CA (US)

(72) Inventor: Kevin Walter Ryniker, San Diego, CA (US)

(73) Assignee: The Invisible Pixel Inc., San Diego, CA (US)

(21) Appl. No.: 18/715,883

(22) PCT Filed: Dec. 6, 2022
(86) PCT No.: PCT/US22/51963

§ 371 Date: Jun. 3, 2024

Related U.S. Application Data
(60) Provisional application No. 63/286,860, filed on Dec. 7, 2021.

(51) Int. Cl. G06T 7/194; G01N 21/64; H04N 23/16; H04N 23/56

(52) U.S. Cl. CPC G06T 7/194; G01N 21/6456; H04N 23/16; H04N 23/56; G06T 2207/10021; G06T 2207/10024; G06T 2207/10064

(57) ABSTRACT

An alpha channel is generated, typically in real time, using image data acquisition that contemporaneously captures image data representing the visible portion of the light spectrum and image data representing the invisible portion of the light spectrum. In some embodiments, the invisible portion of the light spectrum is generated by a fluorescent dye applied to an object or actor in a scene, while in other embodiments the invisible portion of the light spectrum is generated by a light source located behind the object or the actor.

This application claims priority to our copending US Provisional patent application with the Ser. No. 63/286,860, filed Dec. 7, 2021, and which is incorporated by reference herein.

### FIELD OF THE INVENTION

The field of the invention is directed to systems and methods for acquiring image data of an object, especially as it relates to generation of an alpha channel.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In the film industry, green screens or video walls have been utilized as backgrounds of scenes for decades for video and film production. Time-intensive or error-prone postproduction processes, such as chroma keying, and rotoscoping, are utilized to account for these backgrounds.

Rotoscoping describes the process of cutting out an image from one piece of film and compositing it on another. While it began as a rudimentary process relying on razor blades to cut out footage that would then be re-exposed onto a background plate, software, such as Mocha, can be used today. One of the advantages of rotoscoping is a scene can be shot in places or ways that a green screen wouldn't be an option. The scenes can be lit as the director wants without having to compromise for a green stage thus giving the shots an authentic feel. These tools are also used to clean up scenes that are shot on green screen and have unwanted green color “spill” on the subjects. However, even with the incorporation of software, the process is basically the same. It is tedious work that can take a skilled “artist” hours, days or even weeks to clean up green spill and build an alpha channel for even a couple minutes of footage. When the footage has been cut out of the background, it is considered to have an “alpha channel” or a mask.

Green or blue screens are utilized in processes where a scene is shot over a solid color (e.g., green). In postproduction, the green is removed making an alpha channel for the shot. It can be done in real time using hardware (e.g., weather boards, traffic maps, etc.). While green screens render the shots manageable and resources are readily available, the shot can suffer from unwanted green color “spill” on the subjects. This is where the background color reflects into the subject. This can require thousands of man hours to remove on a high-end film. Furthermore, DPs (Director of Photography) and directors are limited in their lighting options due to balancing between proper lighting for the scene for their vision and lighting the scene for a good “key”. Moreover, partially transparent or reflective objects in the scene, such as shadows, smoke, water, partials, animals, fog, chrome, and hair, cause the green to show through. In addition, motion blur, depth of field, or other cinematic effects have an impact on the “key”. Many of these issues can cause a small shoot to go over budget or make what was a decent show with a fair budget look cheap.

In further known attempts, a subject can be filmed in front of a video wall such as a 360 degree LED screen in which the background images are built and rendered in 3D. Notably, the 3D scene is generated in real time as a function of the live camera's location via potentiometers or magnetometers such that the live camera's motion matches the background.

Advantageously, the relatively large LED screen lights the scene, making the live object match the environment. Moreover, such technology entirely avoids green spill and leaves no edges to clean up. However, despite its sophistication, an alpha channel generation has not been realized with such technology.

In still other approaches to track and aminate subjects (e.g., computer generated characters based on live actors), motion capture can be implemented by applying a phosphorescent make up to a subject, exposing the subject to light panels, and tracking the subject using a grayscale camera (see e.g., WO 20120/141770). While such process provides improved tracking and animating of subjects, the process has no impact on objects and backgrounds in scenes in their final form. In yet other known methods, motion capture has been improved by using infrared light and visible light to generate infrared and color images of a subject. An infrared mask is then produced to predict the foreground and background of an image (see US 2010/0302376). However, such process is subject to interference from other infrared light generating devices (e.g., incandescent bulbs) and cannot account for the lighting of the subject. Therefore, the resulting image requires once more significant postproduction work to account for lighting variations and interference.

Thus, even though various systems and methods of acquiring image data of an object are known in the art, all or almost all of them suffer from several drawbacks. Therefore, there remains a need for systems and methods for acquiring image data of an object.

### SUMMARY OF THE INVENTION

The inventive subject matter is directed to various systems for and methods of acquiring image data to facilitate generation of an alpha channel for an object. In some embodiments, the image data are of an object representing a visible portion of the light spectrum reflected by the object and additional image data representing an invisible portion of the light spectrum derived from the same object or from a background behind the object.

In one aspect of the inventive subject matter, a method of acquiring image data of an object is contemplated that includes a step of providing an image acquisition setup configured to contemporaneously acquire image data of the object representing a visible portion of the light spectrum and image data representing an invisible portion of the light spectrum, and a further step of coating the object with a fluorescent dye that that upon illumination with an excitation light fluoresces at a wavelength in the invisible portion of the light spectrum. In still another step, a scene that includes the object is contemporaneously illuminated with (a) natural and/or artificial light, and (b) the excitation light, image data are captured using the image acquisition setup to thereby generate color data representing the visible portion of the light spectrum of the scene and the object and gray scale data representing the invisible portion of the light spectrum of the object.

Preferably, but not necessarily, the visible portion has wavelengths in the range of 400-700 nanometers (nm), and/or the invisible portion has wavelengths of less than 400 nm. Most typically, the fluorescent dye comprises a fluorophore, a fluorescent energy transfer dye, a fluorescent pigment, a fluorescent polymer, a fluorescent protein, or combinations thereof. Most typically, the wavelength range of the excitation light is different than the wavelength range of fluorescence light emitted by the fluorescent dye. For example, the fluorescent dye may be excited by the excitation light at a wavelength of 360 nm and may emit the fluorescence light at a wavelength of 381 nm.

In contemplated methods, the image acquisition setup comprises at least one camera configured to acquire the image data of the object representing the visible portion and/or the image data of the object representing the invisible portion. Where desired, the at least one camera may comprise one or more image sensors configured to generate the color data, the gray scale data, or a combination thereof. Most typically, the image sensor will comprise a red/green/blue (RGB) sensor, an ultraviolet (UV) sensor, an infrared (IR) sensor, or combinations thereof. Additionally, the image acquisition setup may further comprise an auxiliary camera that is configured to track a portion of the object, and the excitation light does not illuminate the portion of the subject.

Therefore, in another aspect of the inventive subject matter, the inventor also contemplates a method of acquiring image data of an object that includes a step of contemporaneously illuminating the object with (a) natural and/or artificial light, and (b) excitation light, and a further step of capturing image data using an image acquisition setup that generates color data representing a visible portion of the light spectrum of the object and that generates gray scale data representing an invisible portion of the light spectrum of the object. In such method it is contemplated that the object comprises a fluorescent dye that emits fluorescence at a wavelength in the invisible portion of the light spectrum upon illumination with the excitation light, and that the excitation light and the fluorescence are in the invisible portion of the light spectrum. For example, visible portion may include wavelengths in the range of 400-700 nanometers (nm), and/or the invisible portion may include wavelengths of less than 400 nm. As noted above, suitable fluorescent dyes include various fluorophores, fluorescent energy transfer dyes, fluorescent pigments, fluorescent polymers, fluorescent proteins, or combinations thereof. Most typically, the wavelength range of the excitation light is different than the wavelength range of the fluorescence light emitted by the fluorescent dye (e.g., the fluorescent dye may be excited by the excitation light at a wavelength of 360 nm and may emit fluorescence light at a wavelength of 381 nm).

In further aspects of such contemplated methods the image acquisition setup comprises at least one camera configured to acquire the image data of the object representing the visible portion and/or the image data of the object representing the invisible portion. Such camera(s) may therefore include one or more image sensors configured to generate the color data, the gray scale data, or a combination thereof. For example, suitable image sensor include a red/green/blue (RGB) sensor, an ultraviolet (UV) sensor, an infrared (IR) sensor, or combinations thereof.

Consequently, the inventor also contemplates a method of generating an alpha channel for an object in image data of a scene containing the object. Such method will typically include a step of providing image data of the scene that includes the object, wherein the image data contain color data representing the visible portion of the light spectrum of the scene and the object and gray scale data representing the invisible portion of the light spectrum of the object. In another step, the gray scale data are then used to isolate the object from the scene, thereby generating an isolated object, and the color data are used for the isolated object to generate the alpha channel for the object.

Viewed from a different perspective, the inventor therefore also contemplates a method of processing image data of an object that includes a step of providing image data of a scene that includes the object, wherein the image data contain color data representing the visible portion of the light spectrum of the scene and the object and gray scale data representing the invisible portion of the light spectrum of the object. In a further step, an alpha channel for the object is then created using the gray scale data.

Thus, in a further aspect of the inventive subject matter, the inventor also contemplates an image acquisition system to capture image data of an object in a scene. Such system will preferably comprise a first camera having a first image sensor that is configured to generate color data representing a visible portion of the light spectrum of the object in the scene, and a second camera having a second image sensor configured to generate gray scale data representing an invisible portion of the light spectrum of the object. Most typically, a filter will be coupled to the second camera that permits travel of light in the invisible portion of the light spectrum to the second image sensor and that reduces or blocks travel of light in the visible portion of the light spectrum to the second image sensor. Furthermore, it is preferred that the first and second cameras are coupled to a carrier and configured to capture the object in the scene along substantially the same line of sight and zoom factor. A light source is then configured to continuously provide an excitation light for a fluorescent dye that emits fluorescent light at the invisible portion of the light spectrum. With respect to the dyes and the wavelengths, the same considerations as noted above apply.

Most typically, the first image sensor comprises a red/green/blue (RGB) sensor while the second image sensor comprises an ultraviolet (UV) sensor. As desired, an auxiliary camera may be configured to track a portion of the object, and the excitation light will not illuminate the portion of the subject based on the tracking of the portion of the subject.

Consequently, an image acquisition system to capture image data of an object in a scene may include a camera having an image sensor that is configured to generate color data representing a visible portion of the light spectrum of the object in the scene and to generate gray scale data representing an invisible portion of the light spectrum of the object. Such system will further include a light source configured to continuously provide an excitation light for a fluorescent dye that emits fluorescent light at the invisible portion of the light spectrum. With respect to the image sensors, dyes, and the wavelengths, the same considerations as noted above apply.

In still further aspects of the inventive subject matter, the inventor further contemplates a method of acquiring image data of an object in front of a background that includes a step of providing an image acquisition setup configured to contemporaneously acquire image data of the object representing a visible portion of the light spectrum and image data of the background representing an invisible portion of the light spectrum; and a further step of contemporaneously illuminating (1) the object with natural and/or artificial light, and (2) the background with light having a wavelength in the invisible portion of the light spectrum. In another step of such methods, image data are captured using the image acquisition setup to thereby generate color data representing the visible portion of the light spectrum of the scene and the object and gray scale data representing the invisible portion of the light spectrum of the object.

Most preferably, the visible portion has wavelengths in the range of 400-700 nanometers (nm), and the invisible portion has wavelengths of less than 400 nm. Furthermore, it is typically preferred that the image acquisition setup comprises first and second sensors, wherein the first sensor acquires image data of the object representing a visible portion of the light spectrum, and wherein the second sensor acquires image data of the background representing an invisible portion of the light spectrum. In some embodiments, the background may comprise a flat surface that is illuminated using a light source that is remotely positioned relative to the flat surface. In other embodiments, the background comprises a flat surface that is illuminated using a light source that is coupled to the flat surface. In further embodiments, the background comprises a video screen, and the video screen comprises a plurality of UV LEDs that illuminate the background.

Therefore, the inventor also contemplates a method of generating an alpha channel for an object in image data of a scene containing the object in front of a background that includes a step of providing image data of the scene that includes the object and the background, wherein the image data contain color data representing the visible portion of the light spectrum of the object and gray scale data representing the invisible portion of the light spectrum of the background. In another step, the gray scale data are used to isolate the object from the background, thereby generating an isolated object, and the color data are used for the isolated object to generate the alpha channel for the object.

For example, the visible portion may include wavelengths in the range of 400-700 nanometers (nm), and the invisible portion may include wavelengths of less than 400 nm. In further examples, image data contain in separate files the color data representing the visible portion of the light spectrum of the object and the gray scale data representing the invisible portion of the light spectrum of the background. As will be readily appreciated, the gray scale data in such method can then be used as a track matte for the color data. Preferably, but not necessarily, the object is isolated from the background in real time.

Viewed from a different perspective, the inventor also contemplates a method of processing image data of an object that includes a step of providing image data of a scene that includes the object in front of a background, wherein the image data contain color data representing the visible portion of the light spectrum of the object and gray scale data representing the invisible portion of the light spectrum of the background. In another step, an alpha channel for the object is then generated using the gray scale data.

In some embodiments, the image data contain in separate files the color data representing the visible portion of the light spectrum of the object and the gray scale data representing the invisible portion of the light spectrum of the background. Where desired, the alpha channel may be generated in real time.

Therefore, the inventor also contemplates an image acquisition system to capture image data of an object in a scene, wherein the object is in front of a background. Such system will typically include a first camera having a first image sensor that is configured to generate color data representing a visible portion of the light spectrum of the object, and a second camera having a second image sensor configured to generate gray scale data representing an invisible portion of the light spectrum of the background. Most typically, a filter is coupled to the second camera that permits travel of light in the invisible portion of the light spectrum to the second image sensor and that reduces or blocks travel of light in the visible portion of the light spectrum to the second image sensor. As noted earlier, it is typically preferred that the first and second cameras are coupled to a carrier and configured to capture the object in the scene along substantially the same line of sight and zoom factor. A light source will then be configured to continuously illuminate the background with the light in the invisible portion of the light spectrum.

Among other options, it is contemplated that the carrier may comprise a stereoscopic camera carrier, and/or that the carrier is configured to coordinate simultaneous lens focusing and/or zoom for the first and second cameras. In some embodiments, the light source is a medium-pressure UV bulb or a UV-light emitting LED. Most typically, the first and second cameras are configured to operate synchronously to produce video streams having the same time code for contemporaneously acquired frames, and the visible portion has wavelengths in the range of 400-700 nanometers (nm), and the invisible portion has wavelengths of less than 400 nm.

Thus, the inventor also contemplates an image acquisition system to capture image data of an object in a scene, wherein the object is in front of a background. Such system may include a camera having a first image sensor that is configured to generate color data representing a visible portion of the light spectrum of the object in the scene and second image sensor to generate gray scale data representing an invisible portion of the light spectrum of the background. As before, a light source will then be configured to illuminate the background with the light in the invisible portion of the light spectrum. In at least some embodiments, the first and second sensors use the same lens (e.g., where the camera comprises a beam splitting mirror).

In still another aspect of the inventive subject matter, the inventor also contemplates a video wall that comprises a first plurality of light emitting pixels that emit light in the visible portion of the light spectrum, and a second plurality of light emitting pixels that emit light in the invisible portion of the light spectrum. Most preferably, the second plurality of pixels are electronically coupled to a circuit that controls illumination of the second plurality of pixels independent from illumination of the first plurality of light emitting pixels. For example, the first plurality of light emitting pixels may be LED or OLED pixels, and/or the second plurality of light emitting pixels are UV-emitting LED or OLED pixels. While not limiting the inventive subject matter, the first plurality and second plurality of pixels will be evenly distributed across at least 70% of the video wall. Moreover, it is generally preferred that the circuit will allow for continuous illumination of the second plurality of pixels at a constant power level while allowing video content to be displayed via the first plurality of pixels. Among other choices, such video wall may be configured as a 360 degree video wall.

Additionally, the inventor also contemplates a video composite wall that includes a display area that is configured to display video content, and a transparent layer that is coupled to the display area such that displayed video content is visible through the transparent layer. Most preferably, the transparent layer will be reflective to light in the invisible portion of the light spectrum and/or may comprise a fluorescent dye that upon excitation emits light in the invisible portion of the light spectrum.

In some embodiments, the display area may be a reflective surface onto which video content is displayed. In further embodiments the transparent layer comprises a transparent polymer, which may comprise a UV-to-UV fluorescent dye. In yet further embodiments, the transparent layer may be coupled to a frame that includes a UV light source.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic illustrating an embodiment of a system for acquiring image data of an object within a scene.

FIG. 2A is a composite spectrum for 4,4-bis-ditertbutyl-carbazole-biphenyl depicting distinct UV-to-UV excitation and fluorescence maxima.

FIG. 2B is a composite spectrum for 2-naphthylamine depicting distinct UV-to-UV excitation and fluorescence maxima.

FIG. 2C is a composite spectrum for 9-phenylcarbazole depicting distinct UV-to-UV excitation and fluorescence maxima.

### DETAILED DESCRIPTION

The inventor has discovered various systems for and methods of acquiring image data of an object. In various embodiments, the image data may be utilized to isolate the object from a background. Advantageously, such isolation can be performed without the need for a green screen and will reduce, or even entirely eliminate the need for post-production editing of the isolated object. In addition, the image data of the isolated object may include lighting information that can be used to match a new background.

To that end, an image acquisition setup will contemporaneously capture light in the visible portion of the spectrum and light form the invisible portion of the spectrum to thereby generate two distinct sets of data. While in some embodiments an object or actor may be coated with a fluorescent dye that is excited with light in the invisible portion of the spectrum (e.g., UV at 360 nm) and that fluoresces with light in the invisible portion of the spectrum (e.g., UV at 381 nm) and so optically identifies the object or actor in the invisible portion of the spectrum, in other embodiments a background is illuminated with light in the invisible portion of the spectrum (e.g., UV at 360 nm) and is obscured by an object or to so optically identify the object or actor as a shadow in the invisible portion of the spectrum. Most typically, image data from the light in the invisible portion of the spectrum will be in form of grayscale data. Regardless of the manner of (foreground or background) illumination, the same object or actor is also illuminated with light in the visible portion of the spectrum to so provide color data. As will be readily appreciated, since both image data represent the same scene at the same time, but in different color space representations, the image data can be readily used to generate an alpha channel.

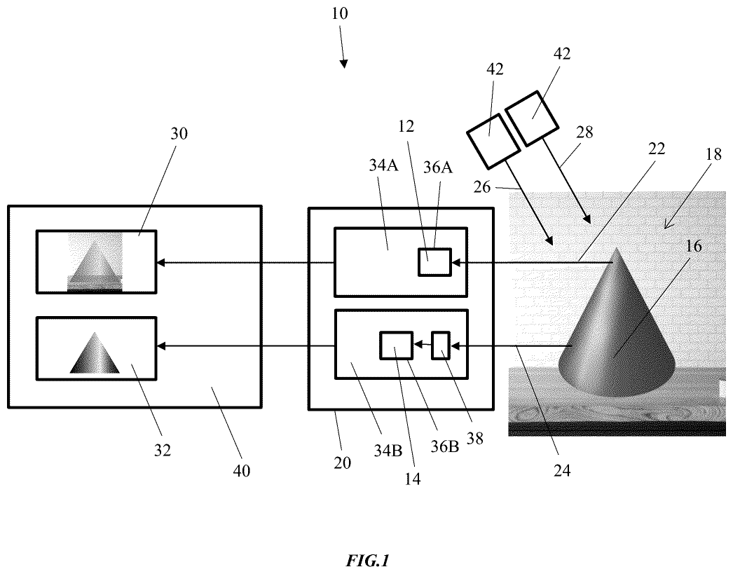

FIG. 1 shows a schematic illustrating an embodiment of a system 10 for acquiring image data 12, 14, of an object 16 within a scene 18. The system 10 includes an image acquisition setup 20 configured to contemporaneously acquire the image data 12 of the object 16 representing a visible portion 22 of the light spectrum (e.g., visible light having wavelengths in the range of 400-700 nanometers (nm)) and image data 14 representing an invisible portion 24 of the light spectrum (e.g., ultraviolet light having wavelengths of less than 400 nm or infrared light having wavelengths of greater than 700 nm). The term “contemporaneously” as used herein means that the image data 12 and the image data 14 are acquired within 1,000 milliseconds (ms), within 100 ms, within 50 ms, within 25 ms, within 10 ms, within 5 ms, within 1 ms, or within 0.1 ms, of each other. Therefore, and viewed form a different perspective, both image data of the object within the scene at a given time may share the same timecode.

The system 10 further includes natural and/or artificial light 26, and an excitation light 28. It is to be appreciated that natural light may include the excitation light 28 (e.g., daylight having wavelengths in the visible light range and the ultraviolet light range). It is also to be appreciated that illumination by the natural and/or artificial light 26 and the excitation light 28 may be direct or indirect. At least one of the artificial light 26 and the excitation light 28 may be provided by a light source 42 configured to continuously provide the at least one of the artificial light 26 and the excitation light 28. The light source 42 may have a high wattage (e.g., 100 watts to 2000 watts for visible light) or an LED equivalent to such source (e.g., for visible and/or UV light). As should be readily appreciated, the light source 42 may include a DX control for a standard DX board, and/or a simple RF remote, and a high/low passthrough filter setup. Thus, the light source 42 may be small or large. Non-limiting examples of smaller lights include higher end GOBO-style lights (e.g., from about 30 cm to about 40 cm in length. The light source 42 may be powered via battery, DC power, or AC power as is well known in the art.

The natural light may be provided in the form of daylight from the sun. The artificial light 26 may be provided by any light source capable of generating at least a portion of the visible portion 22 of the light spectrum (e.g., visible light having wavelengths in the range of 400-700 nanometers (nm)), such as incandescent bulbs, fluorescent lamps, halogen lamps, and light emitting diodes (LEDs). The excitation light 28 may be provided by any light source capable of generating the invisible portion 24 of the light spectrum (e.g., ultraviolet light having wavelengths of less than 400 nm or infrared light having wavelengths of greater than 700 nm), such as UV emitting LEDs, UVA bulbs, UVB bulbs, UVC bulbs, infrared emitting LEDs, and infrared incandescent bulbs.

In the example of FIG. 1, the object 16 is coated with a fluorescent dye (not shown) that upon illumination with the excitation light 28 fluoresces at a wavelength in the invisible portion 24 of the light spectrum (e.g., ultraviolet light having wavelengths of less than 400). Any fluorescent dye known in the art may be utilized so long as it is excited in the invisible portion 24 of the light spectrum and emits fluorescence in the invisible portion 24 of the light spectrum. For example, the fluorescent dye may be derived from or include rare earth minerals and/or a variety of organic (poly)aromatic compounds. In typical embodiments, the wavelength range of the light that excites the fluorescent dye is different than the wavelength range of the light is emitted by the fluorescent dye to minimize any interference generated by the excitation light 28 during acquisition of the image data 14 (i.e., has a significant Stokes' shift). For example, the object 16 may be treated with the fluorescent dye that is excited by light at a wavelength of 360 nm and emits light at a wavelength of 381 nm. However, in various embodiments, it is to be appreciated that the dye may be excited by light having any wavelength less than 400 and may emit light at any wavelength of less than 400 nm so long as the wavelengths do not overlap.

In this context, it should be noted that the term “wavelength” in conjunction with fluorescence excitation or emission herein does not refer to a single wavelength but is meant to refer to a peak in an excitation or emission spectrum that is typically bell-shaped. Therefore, where a fluorescent dye has an excitation wavelength of 360 nm, excitation at 350 nm or 370 nm is not excluded. Most typically, however, the peak will have flanks extending no more than 5-25 nm on either side.

In certain embodiments, the object 16 may have a first area and a second area with the first area coated with a first fluorescent dye and the second area coated with a second fluorescent dye different than the first fluorescent dye. Alternatively, or additionally, a second object (not shown) may be included and be coated with the second fluorescent dye different than the first fluorescent dye. In various embodiments, the first and second fluorescent dyes fluoresce at different wavelengths in the invisible portion 24 of the light spectrum upon illumination with the excitation light 28. Therefore, more than one alpha channel may be generated (e.g., one alpha channel for the first area of the object and a second alpha channel for the second area of the object, or one alpha channel or one object and another alpha channel for another object). Advantageously, it should be appreciated that such multiple alpha channels can be generated at the same time, typically in the same scene and using the same image acquisition setup. It is to be appreciated that more than two fluorescent dyes may be utilized for more than two areas of the object 16 (or objects) to generate more than two alpha channels.

The fluorescent dye may include fluorophores, fluorescent energy transfer dyes, fluorescent pigments, fluorescent polymers, fluorescent proteins, or combinations thereof. The term “fluorophore” as utilized herein means fluorescent chemical compounds that can re-emit light upon light excitation. The phrase “fluorescent energy transfer dyes” as utilized herein means fluorescent dyes including a donor fluorophore and an acceptor fluorophore such that when the donor and acceptor fluorophores are positioned in proximity with each other and with the proper orientation relative to each other, the energy emission from the donor fluorophore is absorbed by the acceptor fluorophore and causes the acceptor fluorophore to fluoresce. The phrase “fluorescent pigments” as utilized herein means that the fluorophore is present in solution in a polymer matrix. Non-limiting examples of suitable fluorescent dyes include coumarins, pyrenes, perylenes, terrylenes, quaterrylenes, naphthalimides, cyanines, xanthenes, oxazines, anthracenes, naphthacenes, anthraquinones, thiazines, fluoresceins, rhodamines, asymmetric benzoxanthenes, xanthenes, phthalocyanines, squaraines, and combinations thereof.

Viewed from a different perspective, the inventor particularly contemplates fluorescent dyes that have an excitation maximum in the UV band of light (preferably invisible to the unaided human eye) and that have a fluorescence emission maximum in a longer wavelength portion of the UV band of light (preferably invisible to the unaided human eye). Therefore, it should be appreciated that preferred compounds presented herein are UV-to-UV fluorescent dyes. As such, even when illuminated at relatively high excitation intensities, the fluorescence will not be perceptible to an observer. Advantageously, fluorescence will not be adversely affected by contemporaneous illumination with light in the visible wavelength.

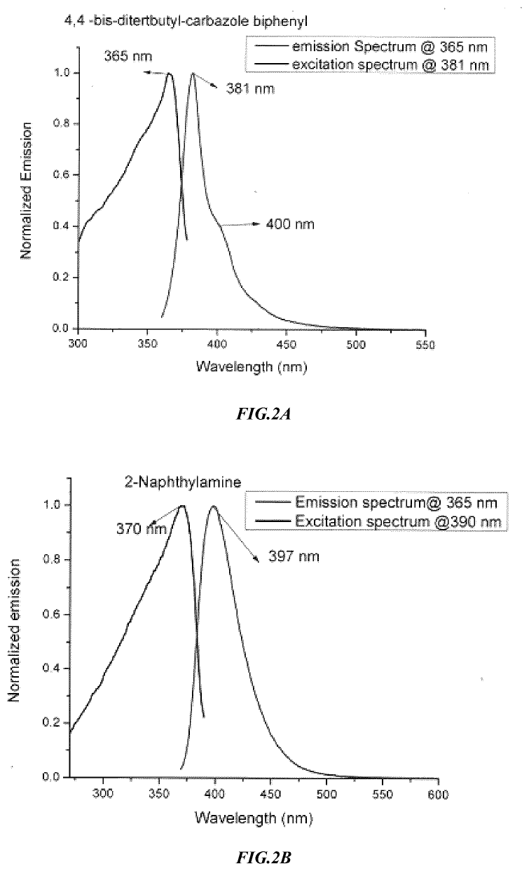

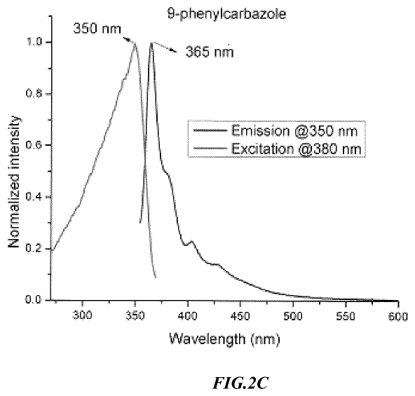

FIGS. 2A-C provide examples suitable for use in conjunction with the teachings presented herein. Here, FIG. 2A depicts a composite spectrum for 4,4-bis-ditertbutyl-carbazole biphenyl having an excitation maximum of about 365 nm and a fluorescence emission maximum of about 381 nm. Similarly, FIG. 2B depicts a composite spectrum for 2-naphthylamine having an excitation maximum of about 370 nm and a fluorescence emission maximum of about 397 nm. In yet another example, as shown in FIG. 2C, a composite spectrum is shown for 9-phenylcarbazole having an excitation maximum of about 350 nm and a fluorescence emission maximum of about 365 nm. As can be seen form the composite spectra, there is some overlap between the excitation spectrum and the fluorescence spectrum, leading to some loss in quantum efficiency. However, in practical use as described herein, all tested compounds worked well for the intended effects. Of course, it should be recognized that the compounds of FIGS 2A-C are merely illustrative of fluorescent dyes, and that all fluorescent dyes are deemed appropriate for use herein (and particularly UV-to-UV fluorescent dyes.

With respect to the particular compound and manner of use of the fluorescent dye it should be noted that the dyes can be used as a fine (micronized) powder dissolved into a suitable solvent to form a clear solution or suspension that allows topical application as a spray (which may or may not evaporate to so deposit the dye), etc. Alternatively, or additionally, other liquids, creams, gels, or solid agents can be used as a carrier for the fluorescent dye, and the proper choice will typically depend on the type of surface to be treated. Therefore, carriers will typically include sprayable liquids, cosmetic formulations, etc. Of course, it should also be noted that the fluorescent dyes may be incorporated into a specific material from which an object is then formed (e.g., via machining, 3D printing, etc.). Where the fluorescence is applied to a large polymer (e.g., Mylar or polyethylene) or tule sheet, the material can be brushed or sprayed on, or such sheet can be manufactured to incorporate the fluorescent dye.

Where desired or otherwise needed, the fluorescent materials can also be applied to a surface that has been pre-treated with a UV absorbing agent. Advantageously, such agent will be beneficial to reduce exposure of live tissue to the UV excitation light, or reduce or eliminate reflection of expiation light from reflective (e.g., metallic) surfaces treated with the UV-to-UV fluorescent dye. Therefore, in some embodiments, surfaces that are coated with the fluorescent dye may include a base coat (e.g., sunscreen) applied to them or a base layer (e.g., clothing) to block the UV light from the subject's surface. For example, UVA wavelengths are readily blocked by conventional sunscreen and clothing and thus the excitation light 28 may be configured to generate only UVA wavelengths.

With further regard to FIG. 1, system 10 is configured to contemporaneously illuminate the scene 18 that includes the object 16 with the natural and/or artificial light 26, and the excitation light 28. The term “contemporaneously” as utilized herein means that the natural and/or artificial light 26 and the excitation light 28 each illuminate the scene 18 within 1,000 milliseconds (ms), within 100 ms, within 50 ms, within 25 ms, within 10 ms, within 5 ms, within 1 ms, or within 0.1 ms, of each other. Most typically, both light sources will at least during some time interval operate at the same time.

The image data 12 and the image data 14 are captured using the image acquisition setup 20 to thereby generate color data 30 representing the visible portion 22 of the light spectrum of the scene 18 and the object 16 and gray scale data 32 representing the invisible portion 24 of the light spectrum of the object 16 (which originates from the fluorescence of the fluorescent dye on the object). The image acquisition setup 20 may include at least one camera 34A and/or 34B configured to acquire at least one of the image data 12 and the image data 14. The at least one camera 34A and/or 34B may include one or more image sensors 36A and/or 36B configured to generate the color data 30, the gray scale data 32, or a combination thereof. Examples of suitable image sensors 36 include a red/green/blue (RGB) sensor, an ultraviolet (UV) sensor, an infrared (IR) sensor, or combinations thereof.

The RGB sensor may include one or more image detector elements such as charge-coupled device (CCD) detector elements, complementary metal oxide semiconductor (CMOS) detector elements, electron multiplying charge coupled device (EMCCD) detector elements, scientific CMOS (sCMOS) detector elements, or other types of visible light detector elements. It is to be appreciated that RGB sensor may be combined with the IR sensor for improving acquisition in low-light environments. In certain embodiments, RGB sensor includes CMOS detector elements, such as those found in Canon brand SLR/DSLR cameras.

The UV sensor may include one or more image detector elements, such as electron multiplied charge-coupled-device (EMCCD) detector elements, scientific complementary metal oxide semiconductor (sCMOS) detector elements, gallium nitride (GaN) detector elements, or other types of ultraviolet light detector elements. In some embodiments, the UV sensor may be configured to have enhanced responsivity in a portion of the UV region of the light spectrum such as the UVA band (e.g., between 315 and 400 nanometers) or UVB band (e.g., between 280 and 315 nanometers) to detect the emission of fluorescent dyes that emit in the UVA band or the UVB band. In other embodiments, the UV sensor may be configured to have enhanced responsivity in a portion of the UV region of the light spectrum such as the UVC band (e.g., between 100 and 280 nanometers) to reduce the solar background for daytime imaging, as well as the anthropogenic background of near-UV, visible and infrared wavelengths that contribute to the background seen by a silicon sensor.

The IR sensor may include one or more image detector elements adapted to detect infrared radiation and provide representative data and information, such as infrared photodetector elements (e.g., any type of multi-pixel infrared detector) for acquiring infrared image data including imagers that operate to sense reflected visible, near infrared (NIR), short-wave infrared (SWIR) light, mid-wave infrared (MWIR) light, long-wave infrared (LWIR) radiation, or combinations thereof. Non-limiting examples include an array of strained layer superlattice (SLS) detectors, uncooled detector elements, cooled detector elements, InSb detector elements, quantum structure detector elements, InGaAs detector elements, or other types of infrared light detector elements.

As will be readily appreciated, the at least one camera 34 may be adjustable for frame per second (FPS), depth of field (DOF), focal distance, motion blur, aperture, or combinations thereof. The at least one camera 34 may include a variety of communication channels, including digital line in and out (e.g., USB, etc.), wireless connectivity (e.g., Bluetooth, WIFI, NFC, etc.), and any other communication channels known in the art for camera.

In certain embodiments, the image acquisition setup 20 includes a first camera 34A having a first image sensor 36A (e.g., the RGB sensor) that is configured to generate the color data 30 representing the visible portion 22 of the light spectrum of the object 16 in the scene 18 and a second camera 34B having a second image sensor 36B (e.g., UV sensor) configured to generate the gray scale data 32 representing the invisible portion 24 of the light spectrum of the object 16. However, it is to be approached that the image acquisition setup 20 may include any combination of sensors associated with one or more cameras. For example, in embodiments when the object 16 is treated with the fluorescent dye that is excited by light at a wavelength of 360 nm and emits light at a wavelength of 381 nm, the second image sensor 36B includes a UV sensor such that the second image sensor 36B can generate the gray scale data 32 representing the invisible portion 24 of the light spectrum (i.e., 381 nm) of the object 16.

The first and second cameras 34A, 34B may be coupled to a (e.g., stereoscopic) carrier and configured to capture the object 16 in the scene 18 along substantially the same line of sight and zoom factor. The term “substantially” as utilized herein with regard to line of sight means that the line of sights for each of the first and second cameras 34A, 34B are within 10°, within 5°, within 4°, within 3, within 2°, within 10, or within 0.10, of each other. The term “substantially” as utilized herein with regard to zoom factor means that the zoom factors for each of the first and second cameras 34A, 34B are within 10%, within 5%, within 4%, within 3%, within 2%, within 1%, or within 0.1%, of each other. In further embodiments, software may be used to account for parallax. Moreover, it should be noted that the operation of the cameras can be synchronized using controls well known in the art.

In other embodiments, the image acquisition setup 20 includes a camera 34 having an integrated image sensor 36 that is configured to generate both, the color data 30 representing a visible portion 22 of the light spectrum of the object 16 in the scene 18 and the gray scale data 32 representing an invisible portion 24 of the light spectrum of the object 16.

In some embodiments, the image acquisition setup 20 further includes a filter 38. The filter 38 may be coupled to the second camera 34B that permits travel of light in the invisible portion 24 of the light spectrum to the second image sensor 36B and the reduces or blocks travel of light in the visible portion 22 of the light spectrum to the second image sensor 36B. In certain embodiments, the filter 38 includes a bandpass filter that transmits UVA radiation and rejects other wavelengths of light such as light having wavelengths less than 315 nm and longer than 400 nm. For example, in embodiments when the object 16 is treated with the fluorescent dye that is excited by light at a wavelength of 360 nm and emits light at a wavelength of 381 nm, the filter 38 may transmit UVA radiation with at least 10% or greater transmission at a center of the desired wavelength range for emission by the fluorescent dye (e.g., between 370 nm and 390 nm). It is to be appreciated that the image acquisition setup 20 may include more than one filter, such as two filters, three filters, four filters, or even more. Likewise, additional filters may also be used with the camera 34A to block or significantly reduce fluorescence excitation and/or emission light.

The system 10 may be further configured to use the gray scale data 32 to isolate the object 16 from the scene 18, thereby generating an isolated object, and using the color data 30 for the isolated object to generate an alpha channel of the object. In particular, the system 10 may be configured to generate the alpha channel for the object 16 using the gray scale data 32. In various embodiments, the alpha channel allows for alpha blending of one image over another. This alpha channel can be utilized to isolate the object 16 from the scene 18, thereby generating the isolated object.

It should be appreciated that numerous software packages are commercially available that can perform the various functions needed for alpha channel generation and video compositing. For example, a variety of 2D compositing programs, animation platforms, or motion graphics, as well as video editing programs are deemed suitable for use. In addition, most 3D software packages have the requisite tools bundled with them. While such packages are suitable, especially preferred software packages will also have dedicated functions to perform compositing, rotoscoping, color keying, and/or green screen production. For example, especially contemplated packages include Adobe After Effects, Premiere, Avid Media composer, Shake, Nuke, Combustion, Primatt, Wondershare Filmora X, Fusion Studio, Autodesk Flame, Natron. Mocha and Sythe eyes are particularly beneficial for rotoscoping, but they all will make an alpha channel. Lightwave, Max Maya are all 3D programs that have chroma keyers built in to their software package.

With continuing reference to FIG. 1, in exemplary embodiments, the object 16 is treated with the fluorescent dye that is excited by light at a wavelength of 360 nm and emits light at a wavelength of 381 nm. The first camera 34A has an RGB sensor for the first image sensor 36A and the second camera 34B has a UV sensor for the second image sensor 36B. The second camera 34B includes the filter 38 that permits travel of light in the invisible portion 24 of the light spectrum at a wavelength of 381 nm and blocks travel of light in the visible portion 22 of the light spectrum and light in the invisible portion 24 at a wavelength of about 360 nm. The object 16 is illuminated with the artificial light 26 that generates the visible portion 22 of the light spectrum. The object 16 is further illuminated with the excitation light 28 that generates the invisible portion 24 of the light spectrum including at least light at a wavelength of about 360 nm, but not light at a wavelength of 381 nm to minimize interference during acquisition by the second camera 34B. The first camera 34A generates the color data 30 representing the visible portion 22 of the light spectrum of the object 16 in the scene 18 in response to acquiring the image data 12 resulting from illumination of the object 16 by the artificial light 26. The second camera 34B generates the gray scale data 32 representing light at a wavelength of 381 nm for the invisible portion 24 of the light spectrum in response to acquiring the image data 14 resulting from illumination of the object 16 by the excitation light 28. Without being bound by theory, the inventors have surprisingly discovered that the image data 14 representing the invisible portion 24 of the light spectrum can be utilized to isolate the object 16 from the scene 18 without the need for significant postproduction processing. Even more advantageously, contemporaneous use of the two different modes of image acquisition allows for a scene and objects to be captured using illumination that is desired by a director while at the same time data can be generated to produce the alpha channel in substantially identical view and perspective. Moreover, as the alpha channel is generated using light invisible to the unaided human eye, any ‘green spill’ otherwise encountered will not be observed.

Furthermore, inventors have surprisingly discovered that the image data 14 provides lighting information of the object 16 that is substantially independent of the material of the object 16 being illuminated, the color of the object 16, or any other attribute of the object 16 that could impact lighting of the object 16. In contrast to conventional acquisition techniques that rely of visible light, the image data 14 results solely from excitation of the fluorescent dye based on illumination of the object 16. Viewed from a different perspective, the attributes of the object 16 that could impact the lighting information resulting from artificial light 26 do not impact the lighting information resulting from the excitation light 28.

The system 10 may further include a computing device 40 capable of controlling the natural and/or artificial light 26, the excitation light 28, and the image acquisition setup 20 for synchronizing acquisition of the image data 12 and the image data 14. Furthermore, the computing device 40 may be capable of analyzing the image data 12 and the image data 14 acquired by the image acquisition setup 20 and the color data 30 and the gray scale data 32 generated by the image acquisition setup 20 for generating the isolated object and for generating the alpha channel for the object. In various embodiments, the computing device 40 includes hardware and software (e.g., Adobe creative suite, Resulume, et.) capable of controlling the components of the system 10 (e.g., a high-end workstation PC).

The system 10 may be further configured operate in a live mode and a rehearsal/action mode. The live mode includes the configuration of the system 10 described above wherein the object 16 is exposed to the excitation light 28 for acquiring the image data 14. On the other hand, the rehearsal/action mode may be utilized to when the scene is scripted as an action scene. In general, during action scenes the subject's faces may not be exposed or the subject is wearing sunglasses, helmets, or costumes that covers their face. Alternatively, the scene may be a long shot.

During the rehearsal/action mode, the natural and/or artificial light 26 and the excitation light 28 are positioned at angles to the subjects and the image acquisition setup 20 is positioned in such a way to make sure that the subjects are fully covered from the cameras' point of view. The rehearsal/action mode may be activated by an operator at a control console (e.g., the computing device 40) or by using the remotes for the lights 26, 28. When the lights 26, 28 are in rehearsal/action mode, the lights 26, 28 emit visible light (e.g., using a 3 color RGB chip which allows for thousands of colors.) The color can be highly saturated.

The scene is then rehearsed to see if the subjects that need an alpha channel are completely covered with light emitting from the lights 26, 28. The positions of the lights 26, 28 can then be adjusted, additional lights 26, 28 can be added, or some of the lights 26, 28 can be removed to obtain the desired conditions. During this rehearsal/action mode, neither the subjects nor the crew are exposed to UV light. When the scene is ready to be shot, the operator puts the lights 26, 28 into the live mode, the colored visible lights of the light 28 are disabled, and the light 28 emits the invisible light (e.g., UV light) covering the same areas with the same relative brightness or density as achieved during the rehearsal/action mode. The UV led is in the same housing as the RGB led for the light 28 so all the light settings, doors flags, positions, etc. apply to the UV led as they do to the RGB led.

For scenes where faces of the subjects are seen close-up or medium shots, the system 10 provides complete coverage of the subjects for generating the alpha channel including their full face. This may be accomplished by capturing the alpha channels in two parts and then combining them using the computing device 40 using well-known compositing software. The lighting set up is primarily the same as above for the live mode with the addition of at least one projector in place of at least one of the lights 28. The projector may emit invisible light in the same wavelength as the light 28 and may have a rehearsal mode as well.

The projector may include an auxiliary camera, such as a webcam or other video acquisition device, coupled thereto positioned so that the focus/field of view is relatively the same as the light 28. In other embodiments, the auxiliary camera is positioned so that the focus/field of view is relatively the same as the second camera 34B. It is to be appreciated that the projector may include multiple auxiliary cameras positioned so that the focus/field of view is relatively the same as the light 28 and the second camera 34B. The computing device 40 may use tracking software in the auxiliary camera to draw a tracking region of interest and create its own mask around subject's faces in real time. The same tracking region is then used to create a real time mask for the projector. The LCD chip in the projector uses the black and white facial recognition tracking region to block that portion of UV light from the projector that would fall on the subject's face. The rest of the subject would still be illuminated by the projector. During rehearsal, the mask can be adjusted to get as tight as possible around the face of the subject. The same mask that is used to block the UV from the subject's face may be recorded as a separate track with the same time code as the primary UV and color tracks. The two tracks would then be combined to make one clean alpha channel.

For this configuration, makeup with the fluorescent dye can be applied to most of the exposed skin where needed. It can be applied to the sides of the face, neck, nose, chin, forehead, and cheeks if needed depending on the shot. The hair, wardrobe, and any other props that needed an alpha channel can be treated. During rehearsal mode the lights project a highly saturated bright color as described above. The facial mask/tracking can be adjusted as far as latency and shape.

In further contemplated embodiments, it should be recognized that the use of visible and invisible light may also be implemented in a manner in which the object or actor need not be covered with the fluorescent dye. Instead, a background will provide a preferably homogenous area of illumination that is generated using a light source that emits light in the invisible part of the spectrum. Of course, and as in the embodiments discussed above, the object of actor in the scene will typically be also illuminated with natural or artificial light in the visible portion of the spectrum. Consequently, it should be appreciated that when the object of actor are in front of the homogenous area of illumination generated using the light source that emits light in the invisible part of the spectrum, the camera that is sensitive to the invisible light will record image data in which the background is visible, and the object/actor is invisible. As such, the object or actor can be easily isolated using the alpha channel generated from the camera that is sensitive to the invisible light.

For example, the system 10 may include a fluorescent panel that is substantially transparent under visible light. The fluorescent panel may be treated with the fluorescent dye that fluoresces under certain wavelengths of light but remains transparent under visible light. As will be readily appreciated, the panel can then be illuminated with excitation light from a desired position away from the panel, or with excitation light from a light source (e.g., LED strip) that is integrated to the top and/or bottom of the panel (for example, in a frame holding the panel, which minimizes excitation light spill). The fluorescent panel may be the alpha channel and thus the object 16 can be isolated from the fluorescent panel. The fluorescent panel may include transparent plastic, mylar, or tulle that has been treated with the fluorescent dye. In these and other embodiments, the excitation light 28 may be behind the centerline of the action and pointed towards the fluorescent panel. It is to be appreciated that the excitation light 28 may require a wide range. Alternatively, in some embodiments, the system 10 does not include the fluorescent panel or only one or more portions of the fluorescent panel is used. In these and other embodiments, the background may be illuminated and thus may function as the alpha channel thereby minimizing exposure of the subject to UV light.

In addition, and as discussed in more detail below, the fluorescent panel may also be replaced by an LED screen (e.g., 360 degree LED screen) that comprises in addition to the LED components that emit visible light also LED elements that emit light in the invisible portion of the spectrum. Such LED elements may be implemented as separately controlled pixels throughout or be provided in separately controlled rows or columns within the LED screen.

During rehearsal mode the excitation light 28 projects a highly saturated bright color as described above to make sure crew and talent are out of the range of lighting of the excitation light 28 and that the fluorescent panel is covered. A UV absorber may be applied to any objects, crew, talent, surfaces, etc. to maximize effectiveness of the resulting alpha channel.

As introduced above, a method of acquiring the image data 12, 14 of the object 16 is provided. The method includes providing the image acquisition setup 20 configured to contemporaneously acquire the image data 12 of the object 16 representing a visible portion 22 of the light spectrum and the image data 14 representing an invisible portion 24 of the light spectrum. The method further includes coating the object 16 with the fluorescent dye that upon illumination with the excitation light 28 fluoresces at a wavelength in the invisible portion 24 of the light spectrum. The method further includes contemporaneously illuminating a scene 18 that includes the object 16 with (a) natural and/or artificial light 26, and (b) the excitation light 28. The method further includes capturing the image data 12, 14 using the image acquisition setup 20 to thereby generate color data 30 representing the visible portion 22 of the light spectrum of the scene 18 and the object 16 and gray scale data 32 representing the invisible portion 24 of the light spectrum of the object 16.

Another method of acquiring image data 12, 14 of the object 16 is provided. The method includes contemporaneously illuminating the object 16 with (a) natural and/or artificial light 26, and (b) excitation light 28. The method further includes capturing the image data 12 using the image acquisition setup 20 that generates the color data 30 representing the visible portion 22 of the light spectrum of the object 16 and that generates gray scale data 32 representing the invisible portion 24 of the light spectrum of the object 16. The object 16 has a coating with a fluorescent dye that emits fluorescence light at a wavelength in the invisible portion 24 of the light spectrum upon illumination with the excitation light 28. The excitation light 28 and the fluorescence light are in the ultraviolet portion of the light spectrum.

A method of generating an alpha channel for the object 16 in the image data 12 of the scene 18 containing the object 16 is also provided. The method includes providing image data 12, 14 of the scene 18 that includes the object 16. The image data 12 contain color data 30 representing the visible portion 22 of the light spectrum of the scene 18 and the object 16 and gray scale data 32 representing the invisible portion 24 of the light spectrum of the object 16. The method further includes using the gray scale data 32 to isolate the object 16 from the scene 18, thereby generating the isolated object. The method further includes using the color data 30 for the isolated object 16 to generate the alpha channel for the object.

A method of processing the image data of an object is also provided. The method includes providing image data 12, 14 of a scene 18 that includes the object 16. The image data 12, 14 contain color data 30 representing the visible portion 22 of the light spectrum of the scene 18 and the object 16 and gray scale data 32 representing the invisible portion 24 of the light spectrum of the object 16. The method further includes generating the alpha channel for the object 16 using the gray scale data 32.

In view of the above, it should be recognized that the alpha channel generator systems and methods presented herein create an alpha channel simultaneously with a color video being shot. Most typically, both video streams are saved (e.g., separately) with the same timecode. Advantageously, the alpha channel is recorded in real time and can be viewed live and played back on location, saving significant production time and time on set. The recorded alpha channel can then be used as any other track matte in post-production using conventional software tools well known in the art. Moreover, the alpha channel generator does not need to be used on a ‘green stage’ and can indeed be used in any location as it creates the alpha channel in the non-visible spectrum of light, rendering the alpha channel generation independent of specific lighting needs. Therefore, the scenes can be shot in the real world and would not have to be lit specifically for green screen. Moreover, it should be appreciated that the lights that the UV capturing camera use to create the alpha channel do not affect the scene and are invisible to the unaided eye.

As a consequence, it should be appreciated that the Director/Director of Photography can light the scene as they wish and generate an alpha channel outdoors, in sunlight, at night, on a green stage, and even on a stage with a video wall. Moreover, contemplated systems and methods allow multiple people and subjects to be in a scene and allow selecting just one actor or parts of an actor to be turned into an alpha channel without the entire cast being on a green stage. Furthermore, contemplated systems and methods presented herein can create alpha channels behind objects that don't need alpha channels themselves, thereby eliminating difficult rotoscoping procedures for scenes that won't track. Finally, it should be recognized that the systems and methods presented herein will not have ‘green spill’ and so require minimal if not even zero render time.

In yet additional benefits, a movie could be played from even a low-end projector on a wall behind the talent where a green screen ordinarily used to be. In front of that wall a transparent screen with UV-to-UV compounds can be placed to so take advantage of proper lighting by the projected video while allowing for generation of an alpha channel using background alpha channel generation.

In the examples below, two general setup configurations of the system and methods presented herein were used: A Foreground Alpha Channel Generation configuration (with one example provided in more detail below) and a Background Alpha Channel Generation configuration (with three examples provided in more detail below). Common to both systems is that Alpha Channel Generation uses two cameras: a standard RBG Video camera and a camera that captures one or more narrow bands of light in the UV A Range (here: wavelengths of 400 nm to 330 nm) as is described in more detail below.

Foreground Alpha setup: The subject that needs the alpha channel is treated with a compound that fluoresces only within the non-visible range. Whatever the compound is applied to and is illuminated with UV light becomes the alpha channel.

Background Alpha setup: This setup is more akin to how a conventional green screen setup is shot. The background becomes the alpha channel, and the subjects are silhouetted against the background. In post-production, the alpha channel is then inverted. Such general setup can be employed in three different variations.

Background Alpha Setup A: The scene has a UV-to-UV fluorescing backdrop created on some type of transparent substrate such as a tule or polymer film that is coated with a UV-to-UV fluorescent compound. The compound is then excited by UV excitation lights and the whole scene will exhibit fluorescence except where subjects are in front of the fluorescing backdrop.

Background Alpha Setup B: The scene has a UV-to-UV fluorescing backdrop in a manner as described above. Once more, where the subjects are in the foreground, they are silhouetted by the UV light coming off the backdrop. If there is more than one subject in the scene and they overlap, a separate alpha channel can be assigned to those subjects. A UV-to-UV fluorescing compound can be applied to the subjects that excites at the same wavelength as the back drop but emits at different wavelengths. Software is then used to assign a color to the different fluorescence wavelengths the compounds are emitting. An alpha channel can also be generated to objects that have no UV-to-UV fluorescing compound on them. Their alpha channel is created by the lights reflecting off surfaces and into the UV capturing camera. This is not as precise but can work well when nothing else will. For example, making an alpha channel for a tree at night in a park.

Background Alpha Setup C: The scene has a partial or complete fluorescing backdrop that uses the UV-to-UV fluorescing compound or that uses embedded LEDs or a combination of them both, over a video playback wall or screen. In further preferred aspects UV-light emitting LEDs are embedded in a video playback wall where the embedded UV-LEDs are controlled by a separate control circuit. Regardless of the particular setup, subjects that require alpha channels are silhouetted against the video screen.

Cameras and Rigs: A typical alpha channel generator system uses 2 cameras attached to some sort of rig that allows either simultaneous filming of the same scene with relatively no or zero parallax, such as a stereoscopic rig. One of the cameras is set up to capture UVA. Ideally, the cameras are of the same make, model, and use the same lenses. Both cameras have filters attached to the lens. The RGB camera has a standard UV blocking filter on it, letting only visible light through (400/405 nm to 700+nm). The filter on the UV camera is normally a bandpass filter with a narrow bandwidth (10 nm) the same as the wavelength of what the UV-to-UV compound fluoresces at, thereby excluding excitation light and permitting fluorescence light to be recorded.

In a typical working example, the cameras were mounted to a rig such as a side-by-side rig or a stereoscopic rig. The RGB and UV cameras shooting were adjusted to have the same field of view with little or no parallax between them (e.g., using the stereoscopic rig). Most typically, the rig has transfer wheels, gears, and rods that coordinate movement of the two lenses for the respective cameras, thereby facilitating simultaneous lens focusing and zoom. As will be appreciated, the settings on the RGB camera (exposure white balance, etc.) can be set remotely or manually.

In one example, the inventor used a setup of 2 identical Cannon 8ti rebels. This setup does not achieve a 0-degree parallax, which would be ideal, but used identical cameras and lenses. Only the capturing chip and some internal filters had been changed in the UV capturing camera to capture the light in the invisible portion of the spectrum. Alternatively, to achieve a zero parallax, the cameras are mounted in a rig similar to one used to shoot 3D or VR, which are commercially available and fit almost all professional cameras. In such setup, one camera shoots through a (semi-transparent) 1 way or beam splitting mirror while the other camera captures the scene that is reflected. While not critical, the UV capturing camera will be the unit capturing the reflected image.

In still further examples, alternative setups are considered in which 2 cameras are not identical as there are very few professional UV video cameras available at this time. While lens distortions could be observed, compositing software can accommodate for such distortions. Alternatively, a small form factor fixed focus UV capturing camera could be employed such as for use with a Go-Pro or similarly dimensioned handheld camera.

For lighting in general it is contemplated that the alpha channel generator lights are UV lights. Their wavelengths can be a full band UVA that is narrowed via filters or UV LEDs that are tuned to a narrow wavelength.

Lighting for Foreground Alpha setup: At least 1 to several high wattage UVA standalone filtered or narrow bandwidth light(s) are used. Where lighting concerns (e.g., highlights, reflective surfaces, etc.) exist, UV soft boxes that emit a narrow bandwidth can be used. The subject that needs the alpha channel will be well lit by the UV that excites the UV-to-UV compound. As will be recognized, consideration of those factors and the scene being shot will determine how many lights and of what configuration are employed.

Lighting for Background Alpha setup: A least one large flat reflector bounce light setup with a narrow UV band OR transparent UV background screen that covers the background in the shot or a very large UV lights meant to light certain elements in the background that are not treated with the UV-to-UV compound. It's best that the background has even coverage to make an alpha that is uniform in value. Once more, consideration of those factors and the scene being shot determines how many lights and of what configuration are needed.

Controlling workstation PC and software: Camera remote controlling and viewing software that comes from the manufacturer of the cameras or similar are suitable for use herein. A PC with a fast video card or 2 PC's that can view both the RGB and UV cameras at the same time will preferably be used. The main function of the workstation is to check and adjust the registration of the 2 video streams so the streams will properly line up. In most cases, the workstation will also run conventional post-production software for playback and comping the alpha channel.

Suitable software for generating the alpha channel is widely commercially available and typically offered by the manufactures of the cameras (e.g., Adobe, Avid, etc.). In addition to being able to composite video streams to generate an alpha channel, preferred software packages will also provide functionalities to line up and register two video streams, and most free remote software that comes bundled with the cameras is sufficient for this purpose. Where more complex functions are required, high-end compositing software often have a large array of camera and lens settings included in their packages. These setting have been supplied by the camera manufacturers for the purpose of removing or adding lens distortion and camera characteristics so that elements built in the computer generated domain will match an environment shot by a specific camera and lens setup in the real-world domain. If after the scenes have been shot and the RGB and UV alpha images are not exactly registered, then final tweaking to correct the registration can be done in post-production. Using software such as Adobe After Effects it is easy to remove parallax or to manually adjust the frame so video streams line-up.

UV-to-UV compound: Specific UV-to-UV compounds are selected for the desired purpose, and 4,4-bis-ditertbutyl-carbazole-biphenyl, 2-naphthylamine, and 9-phenylcarbazole have demonstrated excellent results in all setups. These compounds were mixed with several different media (e.g., Polyethylene, PVA, ethanol) and applied as paint.

When the image capture begins and as the RGB camera is recording, the secondary UV camera is also recording a gray scale image in real time, typically as a separate file, with the same timecode as the RGB camera. This grayscale image is the alpha channel. Both cameras have a live feed to a work station where both cameras playback and remote controls are located. The result is an RGB video of the subject and video of the same scene but in gray scale provided by the respective synchronized cameras. The grayscale image is the alpha channel. Where the compound is fully opaque in the grayscale the image is 255 white. Where there is no compound, the image is 0 black. Where there are transparent parts of the subject you would see a gray scale that varies the strength of the alpha. Once the alpha channel is applied to the RGB image, one can see that the subject has been cut out of the BG.

Foreground Alpha Setup and Action Configuration Setup/Rehearsal mode: This configuration and studio setup is used when the scene is scripted as an action scene or when a singular object needs an alpha for removal. For example, wire removal, scaffolds, or limbs on talent or a hero product island shot. These are scenes where people's faces aren't exposed, they are wearing sunglasses, helmets or costumes that cover their face, or in an extreme long shot. This configuration predominantly uses the UV-to-UV compounds on the foreground objects that need to be isolated.

During setup the lights would be positioned at angles to the subjects and the camera in such a way to make sure that the subjects are fully covered from the cameras POV. During pre-light and rehearsals, the lights are put into rehearsal mode. This is done by the operator at the control console (laptop) or by using the remotes for the lights. When the lights are in rehearsal mode, they are emitting visible light using a 3 color RGB chip which allows for thousands of colors. The color from each light can be highly saturated, Red Yellow Green etc.

The scene is then rehearsed. While in this mode it is easy to see if the subjects that need an alpha channel are completely covered with light coming from the lights. The light positions can then be tweaked, lights can be added or deleted and the scene as far as the key can be finetuned without exposing crew or talent to UV. When the scene is ready to be shot the operator puts the lights into live mode and the colored visible lights turn off and the UV comes on covering the same aeras with the same relative brightness or density. In such scenario, the UV LED is in the same housing as the RGB LEDs so all the light settings, doors flags, positions, etc. apply to the UV as they did to the visible colored light. If the camera tracks, pans or zooms there could also be a key UV light that is aimed directly from the cameras POV at the subject (e.g., attached to the rig).

### Background Alpha Setup

The background alpha setup can conceptually viewed as a green screen where the background is the alpha channel, but instead of a green screen the background fluoresces out of the visible range. Among other options, the background alpha setup can be based on a large piece of transparent plastic, mylar, or tulle that has been treated with the UV-to-UV fluorescing compound.

For example, a transparent screen could be lit by a row of UV emitting LEDs at the top and bottom of the screen or by larger stage type lights. The advantage of this configuration is the UV that is being used to illuminate the clear screen is focused on the UV-to-UV compound only. This modular/mobile transparent backdrop can be deployed almost anywhere and disassembled or broken down easily.

An alternate background setup is one that is reliant on having very large lights. This setup uses no UV screen as a reflective backdrop and could be used outdoors at night end even possibly in sunlight. In that scenario, the UV lights would be behind the centerline of the action and pointed towards the BG. The UV lights in this case could use a wider wavelength range than previously discussed (or be filtered to a wavelength that is closer to the fluorescence emission of the UV-to-UV compound). Indeed, and depending on what is in the background and visual goal to achieve, this setup might not need any UV-to-UV compound as there is sufficient light that reflects off of the objects.

A still further option for the alpha channel generator system described herein is in conjunction with a rear projected video screen or LED wall. Recently, production companies have built custom stages that have a 360-degree video wall running around the perimeter of the studio. This has been built specifically to be used instead of using green screen. By adding UV LEDs to the array of RGB LEDS in the video wall, a clean alpha channel can be generated without effecting the image displayed on the video wall. When manufacturing the video wall, narrow wavelength UV LEDs (e.g., 381 nm emission) could be integrated with each pixel assembly. Alternatively, arrangements other than UV LED pixels are also deemed suitable and include horizontal or vertical narrow LED bars that would not interfere with the video display. Another solution is to use a UV-to-UV transparent screen that would be placed in front of the LED video screen and properly illuminated with UV excitation light. Regardless of the specific configuration, these UV LEDs will be on a separate circuit than the color LEDs and will come on all at the same level or brightness. The dual camera pick-up and the rest of the ACG set-up would be the same as described in the body of this document. It would require the UV camera to be attached to the same rig as the live camera. In such case, no UV-to-UV compounds would be needed.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. The recitation of ranges of values herein is merely intended to serve as a shorthand method of referring individually to each separate value falling within the range. Unless otherwise indicated herein, each individual value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. As also used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification or claims refer to at least one of something selected from the group consisting of A, B, C . . . and N, the text should be interpreted as requiring only one element from the group, not A plus N, or B plus N, etc.

What is claimed is:

1. A method of acquiring image data of an object, comprising:
providing an image acquisition setup configured to contemporaneously acquire image data of the object representing a visible portion of the light spectrum and image data representing an invisible portion of the light spectrum;
coating the object with a fluorescent dye that that upon illumination with an excitation light fluoresces at a wavelength in the invisible portion of the light spectrum;
contemporaneously illuminating a scene that includes the object with (a) natural and/or artificial light, and (b) the excitation light; and
capturing image data using the image acquisition setup to thereby generate color data representing the visible portion of the light spectrum of the scene and the object and gray scale data representing the invisible portion of the light spectrum of the object.

2. The method of claim 1, wherein the visible portion has wavelengths in the range of 400-700 nanometers (nm).

3. The method of claim 1, wherein the invisible portion has wavelengths of less than 400 nm.

4. The method of claim 1, wherein the fluorescent dye comprises fluorophores, fluorescent energy transfer dyes, fluorescent pigments, fluorescent polymers, fluorescent proteins, or combinations thereof.

5. The method of claim 1, wherein the wavelength range of the excitation light is different than the wavelength range of fluorescence light emitted by the fluorescent dye.

6. The method of claim 5, wherein the fluorescent dye is excited by the excitation light at a wavelength of 360 nm and emits the fluorescence light at a wavelength of 381 nm.

7. The method of claim 1, wherein the image acquisition setup comprises at least one camera configured to acquire the image data of the object representing the visible portion and/or the image data of the object representing the invisible portion.

8. The method of claim 7, wherein the at least one camera comprises one or more image sensors configured to generate the color data, the gray scale data, or a combination thereof.

9. The method of claim 8, wherein the image sensor comprises a red/green/blue (RGB) sensor, an ultraviolet (UV) sensor, an infrared (IR) sensor, or combinations thereof.

10. The method of claim 1, wherein the image acquisition setup further comprises an auxiliary camera configured to track a portion of the object, and wherein the excitation light does not illuminate the portion of the subject.

11. A method of acquiring image data of an object, comprising:
contemporaneously illuminating the object with (a) natural and/or artificial light, and (b) excitation light; and
capturing image data using an image acquisition setup that generates color data representing a visible portion of the light spectrum of the object and that generates gray scale data representing an invisible portion of the light spectrum of the object;
wherein the object comprises a fluorescent dye that emits fluorescence at a wavelength in the invisible portion of the light spectrum upon illumination with the excitation light; and
wherein the excitation light and the fluorescence are in the invisible portion of the light spectrum.

12. The method of claim 11, wherein the visible portion has wavelengths in the range of 400-700 nanometers (nm).

13. The method of claim 11, wherein the invisible portion has wavelengths of less than 400 nm.

14. The method of claim 11, wherein the fluorescent dye comprises fluorophores, fluorescent energy transfer dyes, fluorescent pigments, fluorescent polymers, fluorescent proteins, or combinations thereof.

15. The method of claim 11, wherein the wavelength range of the excitation light is different than the wavelength range of the fluorescence light emitted by the fluorescent dye.

16. The method of claim 15, wherein the fluorescent dye is excited by the excitation light at a wavelength of 360 nm and emits the fluorescence light at a wavelength of 381 nm.

17. The method of claim 11, wherein the image acquisition setup comprises at least one camera configured to acquire the image data of the object representing the visible portion and/or the image data of the object representing the invisible portion.

18. The method of claim 17, wherein the at least one camera comprises one or more image sensors configured to generate the color data, the gray scale data, or a combination thereof.

19. The method of claim 18, wherein the image sensor comprises a red/green/blue (RGB) sensor, an ultraviolet (UV) sensor, an infrared (IR) sensor, or combinations thereof.

20. The method of claim 11, wherein the image acquisition setup further comprises an auxiliary camera configured to track a portion of the object, and wherein the excitation light does not illuminate the portion of the subject.

21. A method of generating an alpha channel for an object in image data of a scene containing the object, comprising:
providing image data of the scene that includes the object;
wherein the image data contain color data representing the visible portion of the light spectrum of the scene and the object and gray scale data representing the invisible portion of the light spectrum of the object;
using the gray scale data to isolate the object from the scene, thereby generating an isolated object; and
using the color data for the isolated object to generate the alpha channel for the object.

22. The method of claim 11, wherein the visible portion has wavelengths in the range of 400-700 nanometers (nm).

23. The method of claim 11, wherein the invisible portion has wavelengths of less than 400 nm.

24. A method of processing image data of an object, comprising:
providing image data of a scene that includes the object, wherein the image data contain color data representing the visible portion of the light spectrum of the scene and the object and gray scale data representing the invisible portion of the light spectrum of the object; and
generating an alpha channel for the object using the gray scale data.

25. The method of claim 11, wherein the visible portion has wavelengths in the range of 400-700 nanometers (nm).

26. The method of claim 11, wherein the invisible portion has wavelengths of less than 400 nm.

27. An image acquisition system to capture image data of an object in a scene, comprising:
a first camera having a first image sensor that is configured to generate color data representing a visible portion of the light spectrum of the object in the scene;
a second camera having a second image sensor configured to generate gray scale data representing an invisible portion of the light spectrum of the object;
a filter coupled to the second camera that permits travel of light in the invisible portion of the light spectrum to the second image sensor and that reduces or blocks travel of light in the visible portion of the light spectrum to the second image sensor;
wherein first and second cameras are coupled to a carrier and configured to capture the object in the scene along substantially the same line of sight and zoom factor; and
a light source configured to continuously provide an excitation light for a fluorescent dye that emits fluorescent light at the invisible portion of the light spectrum.

28. The image acquisition system of claim 27, wherein the visible portion has wavelengths in the range of 400-700 nanometers (nm).

29. The image acquisition system of claim 27, wherein the invisible portion has wavelengths of less than 400 nm.

30. The image acquisition system of claim 27, wherein the fluorescent dye comprises a fluorophore, a fluorescent energy transfer dye, a fluorescent pigment, a fluorescent polymer, a fluorescent protein, or combinations thereof.

31. The image acquisition system of claim 27, wherein the wavelength range of the excitation light is different than the wavelength range of the fluorescence light emitted by the fluorescent dye.

32. The image acquisition system of claim 31, wherein the fluorescent dye is excited by the excitation light at a wavelength of 360 nm and emits the fluorescence light at a wavelength of 381 nm.

33. The image acquisition system of claim 27, wherein the first image sensor comprises a red/green/blue (RGB) sensor.

34. The image acquisition system of claim 27, wherein the second image sensor comprises an ultraviolet (UV) sensor.

35. The image acquisition system of claim 27 further comprising an auxiliary camera configured to track a portion of the object, wherein the excitation light does not illuminate the portion of the subject.

36. An image acquisition system to capture image data of an object in a scene, comprising:
a camera having an image sensor that is configured to generate color data representing a visible portion of the light spectrum of the object in the scene and to generate gray scale data representing an invisible portion of the light spectrum of the object; and
a light source configured to continuously provide an excitation light for a fluorescent dye that emits fluorescent light at the invisible portion of the light spectrum.

37. The image acquisition system of claim 36, wherein the visible portion has wavelengths in the range of 400-700 nanometers (nm).

38. The image acquisition system of claim 36, wherein the invisible portion has wavelengths of less than 400 nm.

39. The image acquisition system of claim 36, wherein the fluorescent dye comprises fluorophores, fluorescent energy transfer dyes, fluorescent pigments, fluorescent polymers, fluorescent proteins, or combinations thereof.

40. The image acquisition system of claim 36, wherein the wavelength range of the excitation light is different than the wavelength range of the fluorescence light emitted by the fluorescent dye.

41. The image acquisition system of claim 36, wherein the fluorescent dye is excited by the excitation light at a wavelength of 360 nm and emits the fluorescence light at a wavelength of 381 nm.

42. The image acquisition system of claim 36, wherein the image sensor comprises a red/green/blue (RGB) sensor, an ultraviolet (UV) sensor, an infrared (IR) sensor, or combinations thereof.

43. The image acquisition system of claim 36 further comprising an auxiliary camera configured to track a portion of the object, wherein the excitation light does not illuminate the portion of the subject.

44. A method of acquiring image data of an object in front of a background, comprising:
providing an image acquisition setup configured to contemporaneously acquire image data of the object representing a visible portion of the light spectrum and image data of the background representing an invisible portion of the light spectrum;
contemporaneously illuminating (1) the object with natural and/or artificial light, and (2) the background with light having a wavelength in the invisible portion of the light spectrum; and
capturing image data using the image acquisition setup to thereby generate color data representing the visible portion of the light spectrum of the scene and the object and gray scale data representing the invisible portion of the light spectrum of the object.

45. The method of claim 44 wherein the visible portion has wavelengths in the range of 400-700 nanometers (nm), and the invisible portion has wavelengths of less than 400 nm.

46. The method of claim 44 wherein the image acquisition setup comprises first and second sensors, wherein the first sensor acquires image data of the object representing a visible portion of the light spectrum, and wherein the second sensor acquires image data of the background representing an invisible portion of the light spectrum.

47. The method of claim 44 wherein the background comprises a flat surface that is illuminated using a light source that is remotely positioned relative to the flat surface.

48. The method of claim 44 wherein the background comprises a flat surface that is illuminated using a light source that is coupled to the flat surface.

49. The method of claim 44 wherein the background comprises a video screen, and wherein the video screen comprises a plurality of UV LEDs that illuminate the background.

50. A method of generating an alpha channel for an object in image data of a scene containing the object in front of a background, comprising:
providing image data of the scene that includes the object and the background;
wherein the image data contain color data representing the visible portion of the light spectrum of the object and gray scale data representing the invisible portion of the light spectrum of the background;
using the gray scale data to isolate the object from the background, thereby generating an isolated object; and
using the color data for the isolated object to generate the alpha channel for the object.

51. The method of claim 50 wherein the visible portion has wavelengths in the range of 400-700 nanometers (nm), and the invisible portion has wavelengths of less than 400 nm.

52. The method of claim 50 wherein the image data contain in separate files the color data representing the visible portion of the light spectrum of the object and the gray scale data representing the invisible portion of the light spectrum of the background.

53. The method of claim 50 wherein the gray scale data are used as a track matte for the color data.

54. The method of claim 50 wherein the object is isolated from the background in real time.

55. A method of processing image data of an object, comprising:
providing image data of a scene that includes the object in front of a background, wherein the image data contain color data representing the visible portion of the light spectrum of the object and gray scale data representing the invisible portion of the light spectrum of the background; and
generating an alpha channel for the object using the gray scale data.

56. The method of claim 55 wherein the image data contain in separate files the color data representing the visible portion of the light spectrum of the object and the gray scale data representing the invisible portion of the light spectrum of the background.

57. The method of claim 55 wherein the alpha channel is generated in real time.

58. An image acquisition system to capture image data of an object in a scene, wherein the object is in front of a background, comprising:
a first camera having a first image sensor that is configured to generate color data representing a visible portion of the light spectrum of the object;
a second camera having a second image sensor configured to generate gray scale data representing an invisible portion of the light spectrum of the background;
a filter coupled to the second camera that permits travel of light in the invisible portion of the light spectrum to the second image sensor and that reduces or blocks travel of light in the visible portion of the light spectrum to the second image sensor;
wherein first and second cameras are coupled to a carrier and configured to capture the object in the scene along substantially the same line of sight and zoom factor; and
a light source configured to continuously illuminate the background with the light in the invisible portion of the light spectrum.

59. The image acquisition system of claim 58 wherein the carrier comprises a stereoscopic camera carrier.

60. The image acquisition system of claim 58 wherein the carrier is configured to coordinate simultaneous lens focusing and/or zoom for the first and second cameras.

61. The image acquisition system of claim 58 wherein the light sources is a medium-pressure UV bulb or a UV-light emitting LED.

62. The image acquisition system of claim 58 wherein the first and second cameras are configured to operate synchronously to produce video streams having the same time code for contemporaneously acquired frames.

63. The image acquisition system of claim 58 wherein the visible portion has wavelengths in the range of 400-700 nanometers (nm), and the invisible portion has wavelengths of less than 400 nm.

64. An image acquisition system to capture image data of an object in a scene, wherein the object is in front of a background, comprising:
a camera having a first image sensor that is configured to generate color data representing a visible portion of the light spectrum of the object in the scene and second image sensor to generate gray scale data representing an invisible portion of the light spectrum of the background; and
a light source configured to illuminate the background with the light in the invisible portion of the light spectrum.

65. The image acquisition system of claim 64 wherein the visible portion has wavelengths in the range of 400-700 nanometers (nm), and the invisible portion has wavelengths of less than 400 nm.

66. The image acquisition system of claim 64 wherein the first and second sensors use the same lens.

67. The image acquisition system of claim 64 wherein the camera comprises a beam splitting mirror.

68. A video wall, comprising:
a first plurality of light emitting pixels that emit light in the visible portion of the light spectrum;
a second plurality of light emitting pixels that emit light in the invisible portion of the light spectrum; and
wherein the second plurality of pixels are electronically coupled to a circuit that controls illumination of the second plurality of pixels independent from illumination of the first plurality of light emitting pixels.

69. The video wall of claim 69 wherein the first plurality of light emitting pixels are LED or OLED pixels.

70. The video wall of claim 69 wherein the second plurality of light emitting pixels are UV-emitting LED or OLED pixels.

71. The video wall of claim 69 wherein the first plurality and second plurality of pixels are evenly distributed across at least 70% of the video wall.

72. The video wall of claim 69 wherein the circuit allows for continuous illumination of the second plurality of pixels at a constant power level while allowing video content to be displayed via the first plurality of pixels.

73. The video wall of claim 69 wherein the wall is configured as a 360 degree video wall.

74. A video composite wall, comprising:
a display area configured to display video content;
a transparent layer that is coupled to the display area such that displayed video content is visible through the transparent layer; and
wherein the transparent layer is reflective to light in the invisible portion of the light spectrum and/or comprises a fluorescent dye that upon excitation emits light in the invisible portion of the light spectrum.

75. The video composite wall of claim 74 wherein the display area is a reflective surface.

76. The video composite wall of claim 74 wherein the transparent layer comprises a transparent polymer.

77. The video composite wall of claim 74 wherein the transparent layer comprises a UV-to-UV fluorescent dye.

78. The video composite wall of claim 74 wherein the transparent layer is coupled to a frame that includes a UV light source.
